(19) United States
(12) Patent Application Publication
(10) Pub. No.: US 2013/0162810 A1
(43) Pub. Date: Jun. 27, 2013

(54) APPARATUS FOR INSPECTING ROTARY PARTS AND THE METHOD OF THE INSPECTION

(71) Applicant: Nai En Wu, Singapore (SG)

(72) Inventor: Nai En Wu, Singapore (SG)

(21) Appl. No.: 13/820,290

(22) PCT Filed: Sep. 15, 2010
(86) PCT No.: PCT/SG10/00340

§ 371 Date: Mar. 1, 2013

(51) Int. Cl. G01M 13/04

(52) U.S. Cl. CPC G01M 13/04
USPC 348/92

(57) ABSTRACT

A computer vision inspection system disclosed for use in inspecting of rotary parts like pulley gear or bearing product with internal slots or rails to determine the fabrication quality of the functional dimension of the slots or rails with the help of inspection balls (11) and ball followers (43). The apparatus includes a vision system with camera (30), lens (32), lighting (35), control computer, the image capturing and imaging processing computer program, and the fixture (40) and jig system for the rotary parts and inspection balls (11) and ball followers (43) to ensure the inspection balls are fully engaged into the ball slots (12) or ball rail of the part during inspection. When the checking balls and followers are well engaged to the ball slot or rail of the rotary part, vision image of the inspecting field covering the rotary part and the checking ball or probe, and the fiducial mark (22) on the ball follower (43) or probe head, is captured and transferred to computer program, and then doing the image processing of the captured image to calculate out the functional dimension for the part inspected. The calculated functional dimension value for each part is further recorded into a computer database or factory information system and present into a graph and comparing to the top and bottom limit for easy product quality control.

### FIELD OF THE INVENTION

The present invention relates to technology of vision inspection for rotary parts like a pulley gear or circular bearing with internal slot, and the method of using the apparatus.

### BACKGROUND OF THE INVENTION

Safety is critical for the all industry, and especially for automotive industry. Components quality control in mass production of the rotary parts is very tight. For example, the rotary pulley gear used in one kind of safety belt device. In the safety device like a safety belt, a small pulley gear is used to activate the safety belt when an emergence situation is detected. Such pulley gear may be fabricated by welding (or other joining method) two pieces of molded or stamped half ball slots parts together, to form a complete pulley gear, or machined out by multi-axis CNC machine, or other forming method. An example pulley gear part may be like the one indicated in FIG. 1. The pulley gear 10 has the internal ball slots 12, which may engage with the balls 11 during functioning. FIG. 2 indicates one rotary bearing part 15 with the internal rail 16 which may match to the rotating ball 11 from outside. For such rotary parts, the internal ball slot or rail are key dimensions to keep the balls for smooth gear action, or to ensure smooth bearing action for the balls along the rail.

For the pulley gear with ball slot in between the top cover 17 and bottom cover 18, the gear function requires all ball slots to be well matched with the balls 11 from outside as indicated in FIG. 3. Viewed from the top as FIG. 4, when the balls 11 are all matched into the slots 12, the minimum circle (at diameter of Ds) formed by the outer most ball surface must be within a design range, say Ds_max˜Ds_min. If one or more slots are faulty, the engaged balls may not able to rest within the quality control range of Ds_min˜Ds_max. Such part will be considered as ball slot defect parts.

To check out the ball slot defect parts of the fabricated pulley gears, conventional inspection is often performed manually, with the aid of a GO (with the internal diameter of Ds_max) and a No-Go (with the internal diameter of Ds_min) gauges. When the balls are all engaged into the slots, those good parts will be able pass through the GO gauge, but cannot pass through the No-Go gauge. Otherwise, the parts will be considered as defect parts.

However, the efficiency of manual method is low and depends on operator's skill and workman ship, and is thus not reliable. Further more, the manual inspection by such Go/No-Go gauges can not classify the real functional dimension Ds against the standard design dimension for production management, for example, to grade the fabricated parts or to predict the ware and tear condition of the stamping mold according to the dimension.

For high efficient quality control and improving production management, there is a need to create a better inspection apparatus and the inspection method for such pulley gears or bearings.

### SUMMARY OF THE INVENTION

The present invention is a vision inspection system for the rotating parts such as a pulley gear or bearing. One of the embodiment (embodiment 1) includes a vision system using camera to capture the image of the whole pulley gear part. This embodiment includes a vision camera, lens, lighting, control computer and the image capturing and imaging processing program, and the fixture and jig system for the pulley and inspection ball and pushing bars. As indicated in FIG. 5, the inspecting balls 11 are pushed into every ball slot by the pushing bars 21 and jigs from outside, then the vision system is triggered to capture the image of the pulley gear 10 and the balls 11 and pushing bars 21, and transfer to the computer program. The computer image processing program will do image processing and recognize out all the radial position of the fiducial marks 22 (cross mark or other feature for easy pattern recognition) on each pushing bar 21, and then derive out the pulley gear functional dimension Ds for the inspected part.

However, this method has the limitation in checking resolution. For relatively bigger part, for example, Ds at 55 mm, and higher pixel resolution, for example 10 um/pixel, the vision inspection system requires a large camera FOV (field of view) of about 60×60 mm. To achieve the 10 um/pixel resolution, such camera needs to be at 36 M Pixel resolution. Such inspection system will be at much higher cost, and the image processing needs much longer time to find out the functional dimensions. Also, the mechanical jig and fixture system for all the checking balls is very complicated and high cost.

Another preferred embodiment (embodiment 2) of the invented apparatus to inspect the sample pulley gear is indicated in FIG. 6. It includes the vision system with camera 30, lens 32, lighting 35, control computer and the image capturing and imaging processing program, the jig and fixtures 40 with the integrated inspection balls 11 and ball follower 43, and a rotary indexing stage 50. The vision camera 30, lens 32 and lighting system is positioned above the pulley gear 36 with the FOV 41 coves partial of the pulley gear 36, and the inspecting ball 11 and the ball follower 43 as indicated in FIG. 7. During the inspection cycle, the inspection ball 11 is pushed into the ball slot by the tension or extending springs 45.

As the FOV 41 of the vision system covers only one ball slot of the pulley gear 36, a rotary indexing stage 50 is integrated to index the pulley gear from the first slot till the last slot to be checked by the vision system. During the rotary indexing of the ball slots, vision capturing and the rotary motion synchronizing is achieved by the slot detection sensor to ensure image is captured when the balls are in-line with the fiducial mark 22 (which is engraved on the top surface of the ball follower 43) and the pulley gear center 38. With this partial gear imaging and rotary indexing inspection method, all ball slots inside the pulley gear are inspected, and thus ensure 100% QC control.

As the FOV 41 only covers less than ⅓ of the whole gear part 36, thus only about 1/9 of the camera resolution is needed to achieve the same pixel resolution compared to the vision inspection system with FOV 25 at about 60×60 mm from previous embodiment in FIG. 5.

This embodiment 2 for the present invention also includes a set of automatic computer analysis program. The program will analyze the captured image from FOV 41, and find out the position of datum features like the teeth edge 39 on the pulley gear 36 under inspection, and the fiducial cross mark 22 on the ball follower 43. Since the horizontal distance from the cross mark 22 to the checking ball 11 outer surface is a specified value through the part fabrication, the distance 37 Rs from the checking ball outer surface to the pulley center 38 can be derived out. With all the values of Rs for each ball slot obtained, the pulley gear functional dimension Ds can be derived out. Further, the derived Ds value for each part will be stored into a computer database and present into a graph and comparing to the top and bottom limit (Ds_max and Ds_min) for easy product quality control. This kind of statistic QC data can further be used as reference to predict the life time of the mold and die used in upper stream stamping process.

The method of vision inspection of the pulley gear or similar gear part using the balls to engage to the internal slot or rail by a kind of pushing bar 21 or ball follower 43 with fiducial marks 22, and then use vision system to capture the image of the gear and checking balls and jigs, then computer program do imaging processing to find the reference feature, and thus derives out the functional dimension Ds for the pulley gear 36 under inspection.

### BRIEF DESCRIPTION OF THE DRAWINGS

For a better understanding of the nature and objects of the present invention, reference should be made to the following detailed description taken in connection with the following drawings in which:

FIG. 1 is a sample rotary pulley gear with one matching ball from outside.

FIG. 2 is a sample rotary bearing with one matching ball from outside.

FIG. 3 is a sample rotary pulley gear with all matching balls engaged from outside.

FIG. 4 is the top view of the sample pulley gear with all matching balls engaged from outside, and the indication of the functional dimension Ds.

FIG. 5 is the top view of the vision inspection system embodiment 1 with indication of FOV of the vision system of the pulley gear and the inspection balls and jigs.

FIG. 6 is the isometric view of the preferred embodiment with indications of camera system, pulley gear rotary indexing stage, and the inspecting balls and the jig and fixtures.

FIG. 7 is the top view of the preferred embodiment with indications of FOV of the camera system and the pulley gear and inspecting balls and the ball follower.

### DETAILED DESCRIPTION OF THE INVENTION

The present invention may be understood more readily by reference to the following detailed description of certain embodiments of the invention.

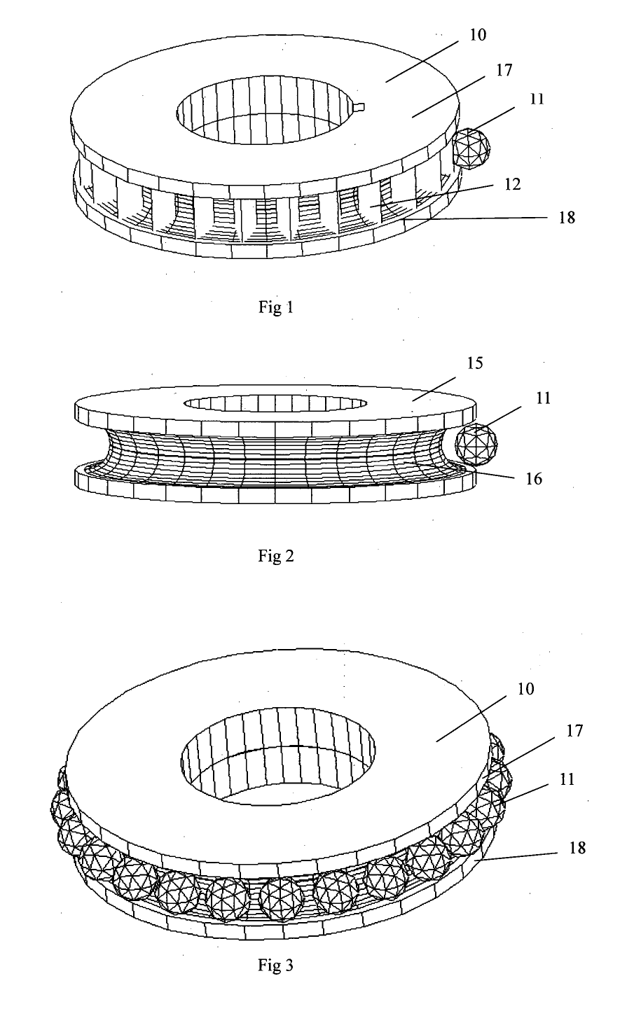

FIG. 1 is a sample rotary pulley gear with one matching ball from outside. The pulley gear 10 has the internal ball slots 12, which may engage with the balls 11 during functioning. The ball slot 12 is formed in between the top cover 17 and bottom cover 18. The top cover 17 and bottom cover 18 may be laser welded together.

FIG. 2 is a sample rotary bearing with one matching ball from outside with the indication of the internal rail 16 which may match to the rotating ball 11 from outside.

FIG. 3 is a sample rotary pulley gear with all matching balls engaged from outside.

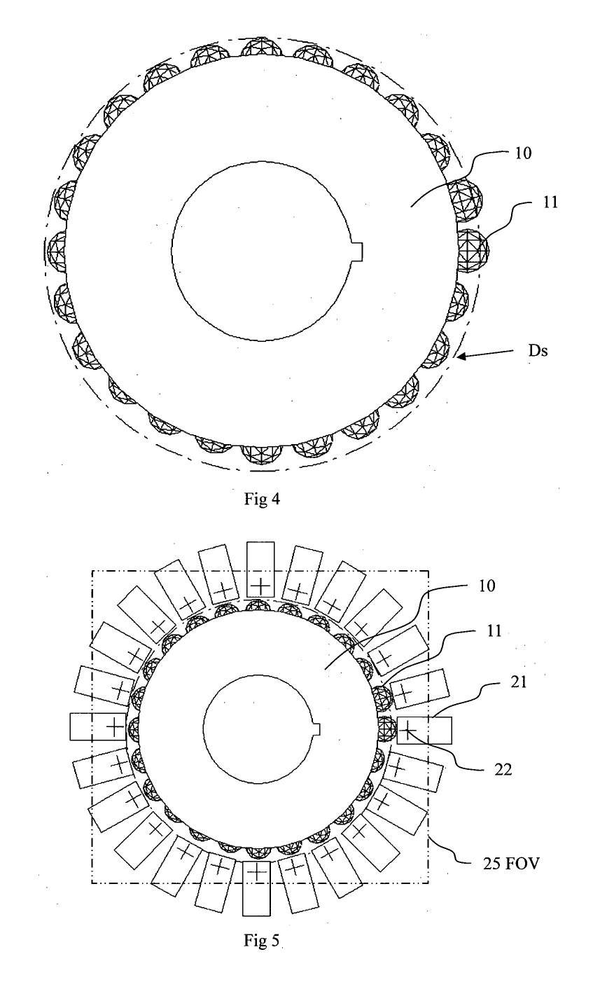

FIG. 4 is the top view of the sample pulley gear with all matching balls engaged from outside, and the indication of the functional dimension Ds. For mass production of such pulley gears, the ball slot profile of all ball slot 12 may not be the same, thus the distance that the matching ball can engage in may be different among all ball slots. For quality control purpose, a tolerance range is given to the design dimension Ds, thus forms a Ds_min and Ds_max. Based on the top and bottom limit dimension, the manual inspection gauge of Go and No-Go are fabricated to filter out the defect parts.

FIG. 5 is the top view of the vision inspection system embodiment 1 with indication of FOV 25 of the vision system of the pulley gear 10 and the inspection balls 11 and jigs including the external pushing bars 21 and the vision fiducial mark 22.

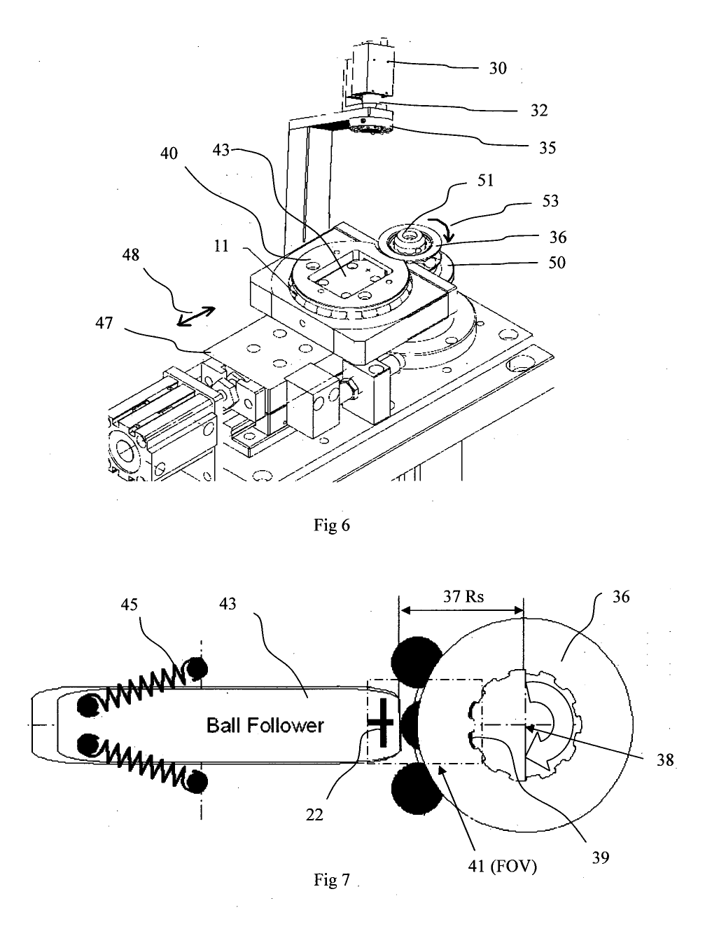

FIG. 6 is the isometric view of the preferred embodiment 2 with indications of camera system including the vision camera 30, lens 32 and lighting system 35, the jig and fixtures 40 with the integrated inspection balls 11 and ball follower 43, and a rotary indexing stage 50.

For the inspection process, first, the pulley gear 36 may be loaded onto the shaft 51 of the rotary indexing stage 50 manually or by an automatic picking and place unit. Then the inspecting ball 11 and the ball follower 43 on the movable fixture 40 may be engaged into the pulley gear 36 along the direction 48 by the actuator and sliding table system 47. Then the pulley gear 36 is rotated (by the rotary stage 50) along the direction 53 to align the inspecting ball 11 in-line with the center 38 of the pulley gear 36, and the fiducial mark 22. Then the camera 30 is triggered to capture the first image of the inspecting field as indicated as FOV 41 in FIG. 7 for the first ball slot. Next, the pulley gear 36 is rotated (by the rotary stage 50) to next slot, and the other inspection ball inside the fixture 40 is driven into the FOV 41 and engaged into the second ball alsot, and the camera is triggered again to take the second image of the inspecting field 41 for the second ball slot. After a whole round of rotary indexing, the image of the FOV 41 are captured for all ball slot on the pulley gear 36. By processing the captured images for all ball slots, the inspecting balls position against the matching ball slots are calculated by the computer image processing program. Then the pulley gear functional dimension Ds can be derived out.

FIG. 7 is the top view of the preferred embodiment 2 with indications of FOV 41 of the camera system and the pulley gear and inspecting balls 11 and the ball follower 43. The ball follower 43 and the springs 45 are to ensure the inspecting balls are fully engaged into the pulley gear 36 during the period of image capturing for the FOV 41 by the camera 30.

This embodiment 2 for the present invention also includes a set of automatic computer analysis program. The program will analyze the captured image from FOV 41, and find out the position of datum features like the teeth edge 39 on the pulley gear 36 under inspection, and the fiducial cross mark 22 on the ball follower 43. Since the horizontal distance from the cross mark 22 to the checking ball 11 outer surface is a specified value through the part fabrication, the distance 37 Rs from the checking ball outer surface to the pulley center 38 can be derived out. With all the values of Rs for each ball slot obtained, the pulley gear functional dimension Ds can be derived out.

What is claimed is:

1. A vision inspection system for quality control of rotary parts like pulley gear or bearing with internal slots or rails to determine the fabrication quality of the functional dimension of the slots or rails, comprising a vision system with camera, lens, lighting, control computer and the image capturing and imaging processing computer program, and the fixture and jig system for the rotary parts and inspection balls to ensure the inspection balls are fully engaged into the ball slots or ball rail of the part being inspected.

2. The vision inspection system according to claim 1, further comprising the control system to engage the inspecting balls into the rotary part being inspected, to capture the image of the whole inspecting field covers the whole part under inspection, and the inspecting balls and recognizable fiducial marks on the push bars or ball follower, and to process the captured image to calculate out the functional dimension for the part inspected.

3. A vision inspection system for quality control of rotary parts like pulley gear or bearing with internal slots or rails to determine the fabrication quality of the functional dimension of the slots or rails, comprising the following components: image capturing vision system with camera, lens, lighting, control computer and the image capturing and imaging processing computer program, and the fixture and jig system to hold the inspecting balls and engage the ball slots or ball rail into the part being inspected, and the rotary indexing stage, which enables the rotary indexing of the rotary part for all the ball slots or rail along the parts outer edges.

4. The vision inspection system according to claim 3, further comprising at least one camera system with camera, lens, and lighting system to be able to be triggered by a control unit or external sensor to capture the recognizable image for the items inside the FOV.

5. The vision inspection system according to claim 3, further comprising the control system to engage the inspecting balls into the rotary part being inspected, to capture the image of the inspecting field which covers partial of the part under inspection, and the inspecting balls and recognizable fiducial marks on the ball follower, and to process the captured images to calculate out the functional dimension for the rotary part.

6. The vision inspection system according to claim 3, further comprising at least one inspecting or checking ball, or probe head with another geometrical shape, which is engaged into the ball slot or rail of the rotary part by a jig or adjustable sliding table.

7. The vision inspection system according to claim 6, further comprising at least one ball follower, or probe head with another geometrical shape, which pushes the inspecting or checking ball towards the ball slot or rail of the rotary part under inspection.

8. The vision inspection system according to claim 7, further comprising at least one fiducial mark on the ball follower, or probe head, for example, a cross mark, for easy image pattern recognition when it is captured into a vision image within the FOV.

9. The image capturing system according to claim 3, further comprising: one or more camera and lens which is able to provide the clear FOV to cover the parts under inspection, the inspecting balls, the ball follower and the fiducial marks for further image processing by the computer program.

10. The image captures system according to claim 3, further comprising: one or more vision lighting, which would illuminate the part under inspection and the ball follower and the fiducial marks with sufficient light intensity to capture image by the camera and lens. the high resolution CCD camera controlled by computer system, which capture the image of the inspecting objects;

11. The vision inspection system according to claim 3, further comprising the image processing program to process the captured image within the vision system FOV to recognizable fiducial marks on the inspecting ball followers and the parts under inspection, and to calculate out the quality control dimension for the parts under inspection.

12. The camera and lens according to claim 9, further comprising one or more high-performance telecentric lenses for use in machine vision, metrology, and precision gauging applications. The lenses may come with adjustable aperture and focus range.

13. A method of inspecting the rotary parts with internal slots or rails like pulley gear or bearing with external engaged checking balls and ball followers, or probe head with another shape, and vision system, and the control system to engage the inspecting balls into the rotary part being inspected, to capture the image of the inspecting field covers the rotary part and the checking ball or probe, and the fiducial mark on the ball follower or probe head, and then doing the image processing of the captured image to calculate out the functional dimension for the part inspected.

14. The claim 13, further comprising the method of store the derived functional dimension Ds value for each part into a computer database or factory information system and present into a graph and comparing to the top and bottom limit (Ds_max and Ds_min) for easy product quality control. This kind of statistic QC data can further be used as reference to predict the life time of the mold and die used in upper stream stamping process.
